(19) United States
(12) Patent Application Publication
(10) Pub. No.: US 2026/0135096 A1
(43) Pub. Date: May 14, 2026

(54) CATHODE ACTIVE MATERIAL FOR LITHIUM-ION SECONDARY BATTERY

(71) Applicant: TOYOTA JIDOSHA KABUSHIKI KAISHA, Toyota-shi (JP)

(72) Inventor: Kenji YOKOE, Toyota-shi (JP)

(73) Assignee: TOYOTA JIDOSHA KABUSHIKI KAISHA, Toyota-shi (JP)

(21) Appl. No.: 19/297,534

(22) Filed: Aug. 12, 2025

(30) Foreign Application Priority Data
Nov. 13, 2024 (JP) 2024-198133

(51) Int. Cl. H01M 4/525; C01G 53/506

(52) U.S. Cl. CPC H01M 4/525; C01G 53/506; C01P 2002/50; C01P 2002/76; C01P 2006/40

(57) ABSTRACT

The present disclosure relates to a cathode active material for a lithium-ion secondary battery. The cathode active material for a lithium-ion secondary battery contains a lithium transition metal composite oxide. A crystal structure of the lithium transition metal composite oxide belongs to a space group R-3m. The lithium transition metal composite oxide contains Ni⁴⁺.

### CROSS-REFERENCE TO RELATED APPLICATION

This application claims priority to Japanese Patent Application No. 2024-198133 filed on Nov. 13, 2024. The disclosure of the above-identified application, including the specification, drawings, and claims, is incorporated by reference herein in its entirety.

### BACKGROUND

### 1. Technical Field

The present disclosure relates to a cathode active material for a lithium-ion secondary battery.

### 2. Description of Related Art

Japanese Unexamined Patent Application Publication No. 2008-257992 (JP 2008-257992 A) discloses a lithium nickel cobalt manganese composite oxide having a layered structure.

### SUMMARY

A lithium transition metal composite oxide can have a layered structure. The layered structure includes 3a sites and 3b sites. The 3a sites and the 3b sites are layered alternately in a c-axis direction. The 3a sites contain lithium ions (Li⁺). The 3b sites contain transition metal (TM) ions. When the 3b sites contain a nickel (Ni) ion, it is generally thought that the Ni ion tends to become trivalent (Ni³⁺).

JP 2008-257992 A discloses that the valence of Ni ions can be fixed to divalent, by an occupancy rate of metal ions other than Ni, cobalt (Co), and manganese (Mn) at the 3b sites being 5% or less. In the battery, the lithium transition metal composite oxide is charged. In a highly charged state, the valence of Ni changes from divalent (Ni²⁺) to tetravalent (Ni⁴⁺). The ionic radius differs between divalent and tetravalent ions. Accordingly, in a highly charged state, the 3b site can rapidly contract in the c-axis direction. Sudden contraction of crystal structures can lead to irreversible structural changes (e.g., change to a rock salt structure or the like). Irreversible structural changes are accompanied by deterioration in capacity. Accordingly, there is a possibility that desired cycle characteristics may not be obtained.

An object of the present disclosure is to improve cycle characteristics.

1. A cathode active material for a lithium-ion secondary battery contains a lithium transition metal composite oxide. A crystal structure of the lithium transition metal composite oxide belongs to a space group R-3m. The lithium transition metal composite oxide contains Ni⁴⁺.

The layered structure belongs to the space group R-3m. In the present disclosure, tetravalent Ni ions are introduced into the crystal structure in advance, before first-time charging in the battery. It is thought that even when valence change occurs with respect to the tetravalent Ni during charging, contraction in the c-axis direction will be mitigated, because the tetravalent Ni ions are originally present. Cycle characteristics are expected to be improved by reducing irreversible structural changes in a highly charged state. Hereinafter, “cathode active material for lithium-ion secondary battery” may be abbreviated to “cathode active material”.

2. The cathode active material according to “1” above may include, for example, the following configuration. The crystal structure includes a 3a site and a 3b site. The 3a site contains Li⁺ and Ni². The 3b site contains Ni⁴⁺ and Ni³⁺.

For example, a divalent Ni ion (Ni²⁺) may be transferred to the 3a site. A phenomenon in which Ni ions transfer to the 3a site is also referred to as “cation mixing (CM)”. The 3b site may contain tetravalent and trivalent Ni ions.

3. The cathode active material according to “2” above may include, for example, the following configuration. A ratio of an amount of substance of Ni⁴⁺ as to an amount of substance of Ni³⁺ is 0.09 to 0.35.

Hereinafter, the ratio of the amount of substance of Ni⁴⁺ as to the amount of substance of Ni³⁺ will also be referred to as molar ratio “Ni⁴⁺/Ni³⁺”. When the molar ratio “Ni⁴⁺/Ni³⁺” is in a range of 0.09 to 0.35, improvement in cycle characteristics is expected.

4. The cathode active material according to “2” or “3” above may include, for example, the following configuration. A ratio of the amount of substance of Ni⁴⁺ as to an amount of substance of Ni²⁺ is 2.7 to 7.2.

Hereinafter, the ratio of the amount of substance of Ni⁴⁺ as to the amount of substance of Ni²⁺ will also be referred to as molar ratio “Ni⁴⁺/Ni²⁺”. When the molar ratio “Ni⁴⁺/Ni²⁺” is in a range of 2.7 to 7.2, improvement in cycle characteristics is expected.

5. The cathode active material according to any one of the above “1” to “4” may include, for example, the following configuration. A composition of the lithium transition metal composite oxide is expressed by a general formula “Li_{z}Ni_{1-c-a}Co_{c}MnₐO_{d}”. In the general formula, “z, a, c, and d” satisfy relations of “0.1≤z≤1.5”, “0.5≤1−c−a≤1.0”, “0≤c≤0.3, 0≤a≤0.3”, and “1.5≤d≤2.1”.

An embodiment of the present disclosure (hereinafter may be abbreviated to “present embodiment”) and an example of the present disclosure (hereinafter may be abbreviated to “present example”) will be described. It should be noted, however, that the present embodiment and the present example do not limit the technical scope of the present disclosure. The present embodiment and the present example are exemplary in all respects. The present embodiment and the present example are not limiting. The technical scope of the present disclosure encompasses all changes within the meaning and scope equivalent to the description of the claims. For example, it is anticipated from the beginning that any configurations may be extracted from the present embodiment and arbitrarily combined.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a graph showing an example of fitting results in Rietveld analysis;

FIG. 2 is an example of an X-ray absorption fine structure (XAFS) spectrum;

FIG. 3 is a table showing results of experimentation;

FIG. 4 is a graph showing a relation between molar ratio “Ni⁴⁺/Ni³⁺” and capacity retention rate; and

FIG. 5 is a graph showing a relation between molar ratio “Ni⁴⁺/Ni²⁺” and capacity retention rate.

### DETAILED DESCRIPTION OF EMBODIMENTS

### Terms and Phrases

“Comprise”, “include”, “have”, and variations thereof are open ended expressions. A configuration expressed as open ended may or may not further include additional elements in addition to the required elements. The term “consist of” is a closed ended expression. However, even configurations that are expressed by closed ended terms can include normally-associated impurities and additional elements that are irrelevant to the pertinent technology. The term “substantially consist of” is a semi-closed ended expression. Configurations that are expressed by semi-closed ended terms allow addition of elements that do not substantially affect the basic and novel characteristics of the pertinent technology.

Numerical values can be expressed in significant figures. Measurement values can be average values of measurements that are made a plurality of times, unless otherwise specified. The number of times of measurements may be 3 times or more, 5 times or more, or 10 times or more. Generally, the greater the number of measurements, is, the more reliability of the average value is expected to improve. Measured values can be rounded off based on the number of digits of the significant figures. Measured values can include error or the like associated with, for example, the detection limit of a measuring device.

The devices, software, and so forth used for measurement and so forth of various types of values are merely examples. Items that are equivalent to devices and so forth that are exemplified may also be used. When equivalent items are used, measurement conditions may be adjusted in accordance with the device.

A space group to which the crystal structure belongs is identified by an X-Ray Diffraction (XRD) pattern. The measurement conditions can be as follows, for example.
Analysis method: Wide-angle
Measurement device: SmartLab II (manufactured by Rigaku Corporation)
Measurement angle: 10° to 120°
Tube: CuKα
Tube voltage: 45 kV
Tube current: 200 mA
Measurement method: Continuous
Step: 0.02
Speed: 2°/min
IS: 1/2
RS: 20 mm
Detection mode: 1-dimensional

When the crystal structure belongs to space group R-3m, the composition ratio of various types of Ni ions (Ni²⁺, Ni³⁺, Ni⁴⁺) in a lithium transition metal composite oxide is further identified by the following procedures. As an example, description will be made regarding a case in which a lithium transition metal composite oxide has a composition that is represented by the following general formula.

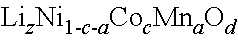

Co at the 3b site is thought to be trivalent (Co³⁺). Mn at the 3b site is thought to be tetravalent (Mn⁴⁺). Ni transferred to the 3a site is thought to be divalent (Ni²⁺). An Ni ion at the 3b site is thought to be trivalent (Ni³⁺) or tetravalent (Ni⁴⁺). When a composition ratio of trivalent (Ni³⁺) is “y”, the above general formula can be rewritten as follows, taking into consideration the configuration of each site.

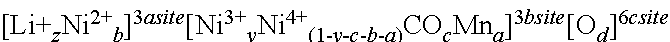

The average valence of Ni in the lithium transition metal composite oxide is assumed to be “n”. The relation “n(1−c−a)=2b+3y+4(1−y−c−b−a)” holds. Accordingly, “y=(4−n)(1−c−a)−2b” is found. The composition ratio of Ni⁴⁺ can also be identified as “1−y−c−b−a” by the composition ratio “y” of Ni³. The “a” and “c” are found by composition analysis. The “b” is found by Rietveld analysis of the XRD pattern. The “n” is found by X-ray absorption fine structure (XAFS) measurement in a hard X-ray region.

The composition of the cathode active material can be measured by inductively coupled plasma atomic emission spectroscopy (ICP-AES). A sample solution is prepared by dissolving 0.1 g of a sample (cathode active material) in a mixed acid (10 ml) of hydrochloric acid and sulfuric acid. The sample solution is diluted to an appropriate concentration using a volumetric flask. After dilution, composition analysis is carried out using an ICP-AES device. For example, product name “PS3520UVDDII (manufactured by Hitachi High-Tech Science Corporation)”, or the like, may be used.

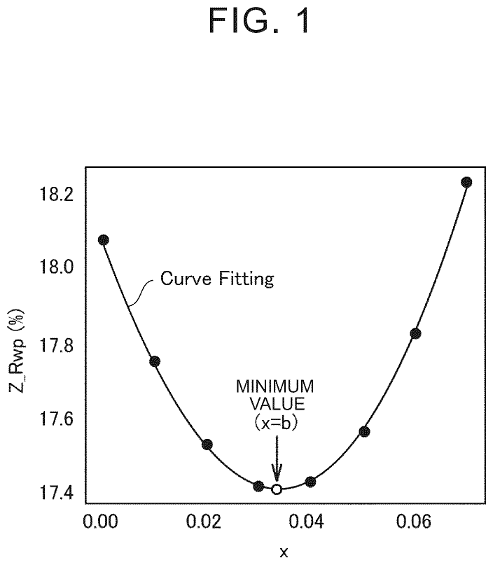

Rietveld analysis is carried out on the XRD patterns using software “GSAS-II”. The structural model is space group R-3m (ITA No. 166). Background processing and structure refinement are carried out on the XRD patterns. Optimization is carried out by setting the Ni²⁺ composition ratio “b” at the 3a site as a variable. Generally, “0≤b≤0.1” can be set. Thus, “Rwp”, which is one of the indices for refinement, is calculated. A quadratic function “αx²+βx+γ” is fitted to the values of Rwp and b. FIG. 1 is a graph showing an example of fitting results in Rietveld analysis. Within the refined range of the approximation curve that is obtained, the x corresponding to the minimum value of Rwp is deemed to be the Ni²⁺ composition ratio “b”. Note that “b/(z+b)” is also referred to as “CM rate”.

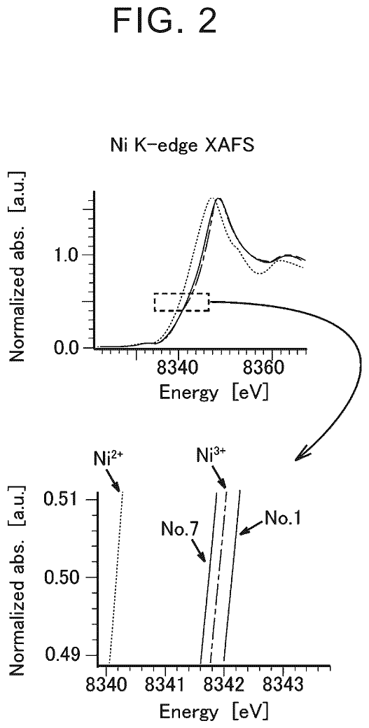

The XAFS measurements may be carried out, for example, at beamline “BL5S1” of the “Aichi Synchrotron Light Center”. A sample is prepared by coating a substrate with a cathode active material. The sample may be part of a cathode plate of a battery. A Quick measurement is carried out by the transmission method over a measurement time of 3 minutes, thereby obtaining an XAFS spectrum at the Ni K absorption edge. The XAFS spectra are normalized using software “Athena”. FIG. 2 is an example of an XAFS spectrum. In the normalized XAFS spectrum, the energy at which the absorption becomes 0.5 is deemed as being the absorption edge energy. The average valence “n” of Ni in the cathode active material is calculated by linear fitting based on the absorption edge energies of standard samples of Ni²⁺, Ni³⁺, and Ni⁴⁺ (e.g., NiO, Ni₂O₃, NiO₂, or the like).

The stoichiometric composition formulas are representative examples of compounds. A compound may have a non-stoichiometric composition. For example, “Al₂O₃” is not limited to a compound having a molar ratio of “Al/O=2/3”. “Al₂O₃” represents a compound containing Al and O in any molar ratio, unless otherwise specified. For example, the compound may be doped with a trace element. Part of Al and O may be substituted with another element.

The term “primary particle” refers to a solid particle that is recognized as being the smallest unit of a particle and that cannot be divided any further. Primary particles do not appear to have particle boundaries in scanning electron microscope (SEM) images. The number of primary particles that are contained in a single-crystal particle or a polycrystalline particle is counted in an SEM image of the powder. The magnification power of the image is, for example, 10,000 times. A primary particle that is independently present, or an aggregate of 2 to 10 primary particles, is deemed to be a single-crystal particle. An aggregate of more than 10 primary particles is deemed to be a polycrystalline particle. A proportion of count of single-crystal particles is identified for 100 particles that are randomly extracted in the SEM image.

“D50” indicates the particle size at which cumulative frequency becomes 50% in a volume-based particle size distribution (cumulative distribution). D50 can be measured by laser diffraction, for example. Similarly to D50, the particle size at which the cumulative frequency becomes 10% is also referred to as “D10”, and the particle size at which the cumulative frequency becomes 90% is also referred to as “D90”.

### Cathode Active Material

The cathode active material is for use in a battery. The battery may be a liquid battery or an all-solid-state battery. The battery may have any structure. The battery may have, for example, a wound or laminated type power generating element. The battery may, for example, have a unipolar structure or a bipolar structure.

The cathode active material contains a lithium transition metal composite oxide. The term “lithium transition metal composite oxide” refers to a compound containing Li, a transition metal (TM), and oxygen (O). A crystal structure of the lithium transition metal composite oxide belongs to a space group R-3m. The crystal structure belonging to space group R-3m is also referred to as “layered structure”.

The layered structure includes 3a sites (Li sites), 3b sites (TM sites) and 6c sites (O sites). The 3a sites contain Lit. The 3b sites contain Ni ions. An exchange phenomenon (CM) may occur between some of the Li ions at the 3a sites and some of the Ni ions at the 3b sites. The Ni ions transferred to 3a sites may be divalent (Ni²⁺). The ionic radius of Li⁺ is 0.76 Å. The ionic radius of trivalent Ni ions (Ni³⁺) is 0.56 Å to 0.60 Å. The ionic radius of divalent Ni ions (Ni²⁺) is 0.69 Å. Ni²⁺ has an ionic radius closer to that of Li⁺ in comparison with that of Ni³⁺, and accordingly it is thought that Ni²⁺ is stable within the 3a site. Thus, the 3a sites may contain Li⁺ and Ni²⁺.

The 3b sites contain Ni⁴⁺. That is to say, the lithium transition metal composite oxide contains Ni⁴⁺. The presence of Ni⁴⁺ in the crystal structure is expected to improve cycle characteristics. It is thought that Ni⁴⁺ is not introduced into the crystal structure by conventional synthesis methods. According to the new findings of the present disclosure, Ni⁴⁺ can be introduced into the 3b site by charging an excess amount of Li source during synthesis and also performing appropriate washing with water after firing.

The 3b site may further contain Ni³⁺ in addition to Ni⁴⁺. The molar ratio “Ni⁴⁺/Ni³⁺” may be, for example, more than 0, 0.02 or more, 0.04 or more, 0.06 or more, 0.08 or more, 0.09 or more, 0.10 or more, 0.12 or more, 0.14 or more, 0.16 or more, 0.18 or more, 0.20 or more, 0.21 or more, 0.22 or more, 0.24 or more, 0.26 or more, 0.28 or more, 0.30 or more, 0.32 or more, 0.34 or more, 0.35 or more, 0.36 or more, 0.38 or more, 0.40 or more, 0.42 or more, 0.44 or more, 0.46 or more, 0.48 or more, or 0.50 or more. The molar ratio “Ni⁴⁺/Ni³⁺” may be, for example, 5 or less, 4 or less, 3 or less, 2 or less, 1 or less, 0.90 or less, 0.80 or less, 0.70 or less, 0.60 or less, 0.50 or less, 0.48 or less, 0.46 or less, 0.44 or less, 0.42 or less, 0.40 or less, 0.38 or less, 0.36 or less, 0.35 or less, 0.34 or less, 0.32 or less, 0.30 or less, 0.28 or less, 0.26 or less, 0.24 or less, 0.22 or less, 0.21 or less, 0.20 or less, 0.18 or less, 0.16 or less, 0.14 or less, 0.12 or less, 0.10 or less, 0.09 or less, 0.08 or less, 0.06 or less, 0.04 or less, or 0.02 or less. For example, when the molar ratio “Ni⁴⁺/Ni³⁺” is in a range of 0.09 to 0.35, improvement in cycle characteristics can be expected.

The molar ratio “Ni⁴⁺/Ni²⁺” may be, for example, more than 0, 1 or more, 2 or more, 2.4 or more, 2.7 or more, 2.8 or more, 3.2 or more, 3.6 or more, 3.8 or more, 4.0 or more, 4.4 or more, 4.8 or more, 5.2 or more, 5.6 or more, 6.0 or more, 6.4 or more, 6.7 or more, 6.8 or more, 7.2 or more, 7.6 or more, 8.0 or more, 9.0 or more, 10.0 or more, 12.0 or more, 14.0 or more, 16.0 or more, 16.8 or more, 18.0 or more, or 20.0 or more. The molar ratio “Ni⁴⁺/Ni²⁺” may be, for example, 40.0 or less, 30.0 or less, 20.0 or less, 18.0 or less, 16.8 or less, 16.0 or less, 14.0 or less, 12.0 or less, 10.0 or less, 9.0 or less, 8.0 or less, 7.6 or less, 7.2 or less, 6.8 or less, 6.7 or less, 6.4 or less, 6.0 or less, 5.6 or less, 5.2 or less, 4.8 or less, 4.4 or less, 4.0 or less, 3.8 or less, 3.6 or less, 3.2 or less, 2.8 or less, 2.7 or less, 2.4 or less, 2 or less, or 1 or less. For example, when the molar ratio “Ni⁴⁺/Ni²⁺” is in a range of 2.7 to 7.2, improvement in cycle characteristics can be expected.

The 3b site may further contain Co, Mn, and so forth, in addition to Ni. The lithium transition metal composite oxide may have a composition that is represented by the general formula “Li_{z}Ni_{1-c-a}Co_{c}MnₐO_{d}”, for example. The Li composition ratio “z” may satisfy a relation of “0.1≤z≤1.5”, for example. The Li composition ratio “z” may be, for example, 0.4 or more, 0.6 or more, 0.8 or more, 1.0 or more, 1.2 or more, or 1.4 or more. The Li composition ratio “z” may be, for example, 1.4 or less, or 1.2 or less.

In the above general formula, the O composition ratio “d” may satisfy a relation of, for example, “1.5≤d≤2.1”. The O composition ratio “d” may be, for example, 1.6 or more, 1.7 or more, 1.8 or more, 1.9 or more, or 2.0 or more. The O composition ratio “d” may be, for example, 2.0 or less, 1.9 or less, 1.8 or less, 1.7 or less, or 1.6 or less.

In the above general formula, the Ni composition ratio “1−c−a” may satisfy a relation of, for example, “0.5≤1−c−a≤1.0”. The Ni composition ratio “1−c−a” may be, for example, 0.6 or more, 0.7 or more, 0.8 or more, or 0.9 or more. The Ni composition ratio “1−c−a” may be, for example, 0.9 or less, 0.8 or less, 0.7 or less, or 0.6 or less. When the Ni composition ratio “1−c−a” is 0.5 or more, increase in discharge capacity can be expected.

In the above general formula, the Co composition ratio “c” may satisfy a relation of, for example, “0≤c≤0.3”. The Co composition ratio “c” may be, for example, 0.01 or more, 0.02 or more, 0.03 or more, 0.04 or more, 0.05 or more, 0.06 or more, 0.07 or more, 0.08 or more, 0.09 or more, 0.10 or more, 0.15 or more, 0.20 or more, or 0.25 or more. The Co composition ratio “c” may be, for example, 0.25 or less, 0.20 or less, 0.15 or less, 0.10 or less, 0.09 or less, 0.08 or less, 0.07 or less, 0.06 or less, 0.05 or less, 0.04 or less, 0.03 or less, 0.02 or less, or 0.01 or less.

In the above general formula, the Mn composition ratio “a” may satisfy a relation of “0≤a≤0.3”, for example. The Mn composition ratio “a” may be, for example, 0.01 or more, 0.02 or more, 0.03 or more, 0.04 or more, 0.05 or more, 0.06 or more, 0.07 or more, 0.08 or more, 0.09 or more, 0.10 or more, 0.15 or more, 0.20 or more, or 0.25 or more. The Mn composition ratio “a” may be, for example, 0.25 or less, 0.20 or less, 0.15 or less, 0.10 or less, 0.09 or less, 0.08 or less, 0.07 or less, 0.06 or less, 0.05 or less, 0.04 or less, 0.03 or less, 0.02 or less, or 0.01 or less.

Note that in the above general formula, all or part of Mn may be substituted with Al or the like. That is to say, the lithium transition metal composite oxide may have a composition that is represented by the general formula “Li_{z}Ni_{1-c-a}Co_{c}AlₐO_{d}”, for example. The range of the Al composition ratio “a” is the same as that of the Mn composition ratio “a” described above.

An optional dopant may be added to the lithium transition metal composite oxide. The term “dopant” refers to an element other than Li, Ni, Co, Mn, and O. The dopant may include, for example, at least one type that is selected from a group consisting of Zr, Mo, W, Mg, Ca, Na, Fe, Cr, Zn, Si, Sn, Al, and Ag. The composition ratio of the dopant may be, for example, 0.005 or more, 0.01 or more, 0.02 or more, 0.03 or more, or 0.04 or more. The composition ratio of the dopant may be, for example, 0.05 or less, 0.04 or less, 0.03 or less, 0.02 or less, or 0.01 or less.

The cathode active material may be in the form of a powder. The D50 of the cathode active material may be, for example, 1 μm or more, 3 μm or more, 5 μm or more, 10 μm or more, or 15 μm or more. The D50 of the powder may be, for example, 30 μm or less, 20 μm or less, or 10 μm or less.

The lithium transition metal composite oxide may be in the form of single-crystal particles. The lithium transition metal composite oxide may be in the form of polycrystalline particles. That is to say, the cathode active material may contain single-crystal particles and polycrystalline particles. The polycrystalline particles may have substantially the same crystal structure and composition as the single-crystal particles. The cathode active material (powder) may be made up of, for example, 50% or more single-crystal particles in terms of proportion of count, and the remainder of polycrystalline particles. The proportion of count of the single-crystal particles may be, for example, 60% or more, 70% or more, 80% or more, or 90% or more. The proportion of count of single-crystal particles may be, for example, 100% or less, 90% or less, or 80% or less. For example, when the proportion of count of single-crystal particles is 70% or more, improvement in cycle characteristics can be expected. This is believed to be because single-crystal particles have fewer particle boundaries than polycrystalline particles, and therefore are less susceptible to cracking due to charging and discharging (volume change).

It is expected that the smaller the number of primary particles making up a single-crystal particle is, the less likely cracking will occur. The number of primary particles making up the single-crystal particle may be, for example, 9 or less, 8 or less, 7 or less, 6 or less, 5 or less, 4 or less, 3 or less, or 2 or less. The number of primary particles making up the polycrystalline particle may be, for example, 15 or more, 20 or more, 25 or more, or 50 or more. The number of primary particles making up the polycrystalline particle may be, for example, 100 or less, 50 or less, 25 or less, or 20 or less. For example, when a single-crystal particle is redefined to include 5 or less primary particles, the proportion of count above refers to the proportion of count of single crystal particles after the redefinition.

The cathode active material (powder) may be a monodisperse system. Due to the powder being mainly made up of single-crystal particles, and also being a monodisperse system, improvement in cycle characteristics can be expected. The powder may, for example, have a span of 1 or less. The term “span” indicates a value calculated by a formula “(D90−D10)/D50”. It is thought that the smaller the span is, the sharper the particle size distribution is. The span of the powder may be, for example, 0.9 or less, 0.8 or less, 0.7 or less, 0.6 or less, or 0.5 or less. The span of the powder may be, for example, 0.1 or more, 0.2 or more, 0.3 or more, 0.4 or more, or 0.5 or more.

### Sample Fabrication

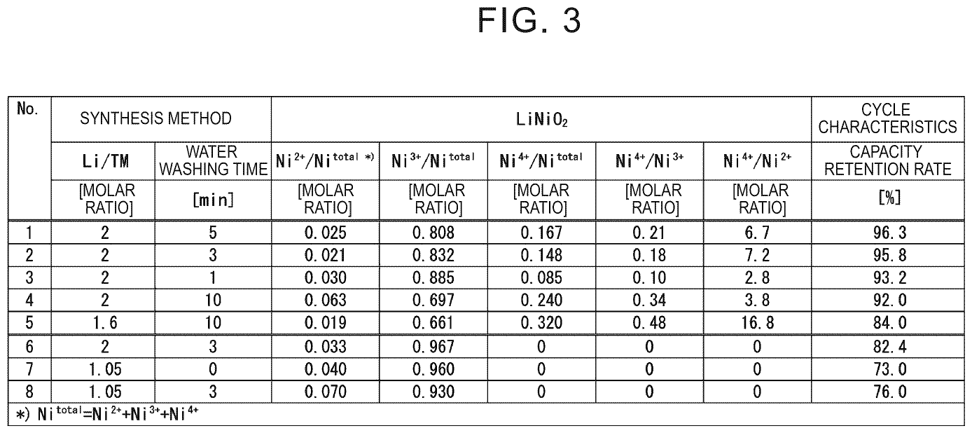

FIG. 3 is a table showing results of experimentation. Samples No. 1 to No. 8 were fabricated according to the following procedures.

### Precursor Preparation

A raw material solution is prepared by dissolving NiSO₄ in ion-exchanged water. An amount of substance concentration of the raw material solution is 0.2%. Note that when a target substance is “LiNi_{0.90}Co_{0.05}Mn_{0.05}O₂”, for example, a raw material solution is prepared by dissolving NiSO₄, CoSO₄, and MnSO₄ in ion-exchanged water. The compound ratio of NiSO₄, CoSO₄, and MnSO₄ is adjusted so as to be “Ni/Co/Mn=90/5/5 (molar ratio)”.

A predetermined amount of NH₃ aqueous solution is placed in a reaction vessel. Gasses inside the reaction vessel are replaced with nitrogen gas, while stirring the contents thereof with a stirrer. Adding NaOH to the contents of the reaction vessel adjusts the pH of the aqueous solution to be alkaline. The raw material liquid is added dropwise while the temperature and the pH of the aqueous solution are adjusted to be kept within a certain range (a substantially constant value), thereby forming a precipitate of TM hydroxide (Ni hydroxide). The precipitate is subjected to dehydration and pre-firing. The pre-firing temperature is 120° C. to 220° C. The pre-firing time is 4 to 10 hours. The pre-firing pressure is 0.2 MPa to 1.0 MPa.

After the pre-firing, the precipitate is washed with water. A residue (TM hydroxide) is recovered by filtration. The TM hydroxide is dried at 110° C. for 12 hours to remove moisture. Thus, a precursor (TM hydroxide) is prepared.

### Addition of Li Source

A mixture is prepared by mixing the precursor (TM hydroxide) and a lithium compound (LiOH) in an agate mortar. The lithium compound may be, for example, Li₂CO₃ or the like. The ratio of the amount of substance of Li as to the total amount of substance of TM (Ni), which is “Li/TM”, is shown in the “Li/TM” column in FIG. 3. For example, when “Li/TM” is greater than 1, a molten salt is formed during firing, and single crystallization of the lithium transition metal composite oxide can be promoted. That is to say, the proportion of count of single-crystal particles in the powder can be expected to be 70% or more.

### Firing

The mixture is subjected to thermal treatment in a firing furnace to produce a cathode active material. The firing temperature is 650° C. to 1100° C. The firing time is 5 hours to 15 hours.

After firing, the cathode active material is crushed in an agate mortar until the particle size is 0.2 mm or smaller. The cathode active material is dispersed in 500 mL of pure water to form a slurry. The slurry is vigorously stirred for a predetermined amount of time. That is to say, the cathode active material is washed with water. The water washing time for each sample is shown in the “Water Washing Time” column in FIG. 3. Washing with water was not carried out for No. 7.

After washing with water, the slurry is filtered using filter paper and a Buchner funnel. The residue is rinsed with 500 mL of pure water to form a cake. The cake is vacuum dried at 90° C. After drying, the cake is crushed in an agate mortar to adjust the particle size to a predetermined size. For example, the cake may be crushed using a lab mill, some other mill, or the like. Thus, the cathode active material (LiNiO₂) is produced. The crystal structure and the composition ratio of Ni²⁺, Ni³⁺, and Ni⁴⁺ are identified for each sample by Rietveld analysis. As an example, the XAFS spectra of No. 1 and No. 7 are shown in FIG. 2.

### EVALUATION

A laminate cell is prepared. The term “laminate cell” refers to a cell in which a power generating element is housed in a pouch made of an Al laminate film. The configuration of the power generating element is as follows.
Cathode: cathode active material, conductive material (acetylene black)
Anode: anode active material (natural graphite)
Electrolyte: LiPF₆ (1 mol/L), EC/DMC/EMC=3/4/3 (volumetric ratio)

The cathode and the anode are produced by applying slurry to a surface of a substrate (metal foil). As the coating device, a film applicator (with film thickness adjustment function), manufactured by Allgood Co., Ltd., for example, is used. After applying the slurry, a coating thus formed is dried at 80° C. for 5 minutes.

Cycle tests were carried out on the laminate cell under the following conditions.
Ambient temperature: 60° C.
Number of cycles: 100
Current rate: 0.3 C
Voltage range: 4.25 V to 2.5 V

At a current rate of 1 C, the rated capacity of the cell is drained in 1 hour. 0.3 C is 0.3 times 1 C. The capacity retention rate is calculated by dividing the discharge capacity at the 100th cycle by the discharge capacity at the first cycle. It is thought that the higher the capacity retention rate is, the better the cycle characteristics will be.

### Experiment Results

In FIG. 3, the description “Ni⁴⁺/Ni^{total}”, for example, indicates the proportion of the amount of substance of Ni⁴⁺ as to the total amount of substance of Ni²⁺, Ni³⁺, and Ni⁴⁺.

As shown in FIG. 3, the presence of Ni⁴⁺ in the crystal structure tends to improve cycle characteristics.

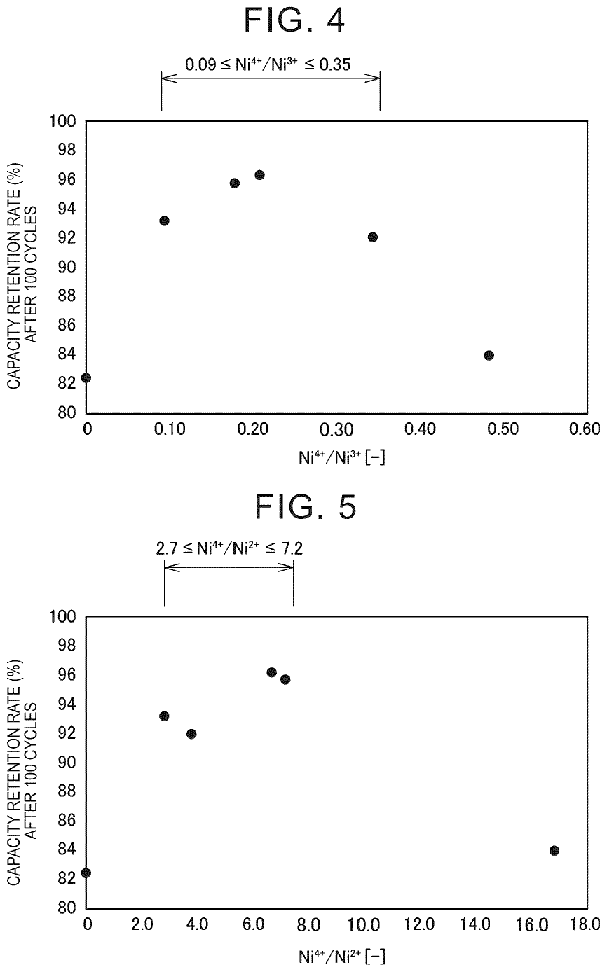

FIG. 4 is a graph showing a relation between molar ratio “Ni⁴⁺/Ni³⁺” and capacity retention rate. When the molar ratio “Ni⁴⁺/Ni³⁺” is 0.09 to 0.35, the cycle characteristics tend to improve. In a region where the molar ratio “Ni⁴⁺/Ni³⁺” exceeds 0.35, formation of an inactive region in part of the crystal structure can be expected, due to Li deficiency becoming excessive.

FIG. 5 is a graph showing a relation between molar ratio “Ni⁴⁺/Ni²⁺” and capacity retention rate. When the molar ratio “Ni⁴⁺/Ni²⁺” is 2.7 to 7.2, the cycle characteristics tend to improve.

What is claimed is:

1. A cathode active material for a lithium-ion secondary battery, the cathode active material containing
a lithium transition metal composite oxide, wherein
a crystal structure of the lithium transition metal composite oxide belongs to a space group R-3m, and also
the lithium transition metal composite oxide contains Ni⁴⁺.

2. The cathode active material according to claim 1, wherein
the crystal structure includes a 3a site and a 3b site,
the 3a site contains Li⁺ and Ni²⁺, and also
the 3b site contains Ni⁴⁺ and Ni³⁺.

3. The cathode active material according to claim 2, wherein a ratio of an amount of substance of Ni⁴⁺ as to an amount of substance of Ni³⁺ is 0.09 to 0.35.

4. The cathode active material according to claim 2, wherein a ratio of an amount of substance of Ni⁴⁺ as to an amount of substance of Ni²⁺ is 2.7 to 7.2.

5. The cathode active material according to claim 2, wherein
a composition of the lithium transition metal composite oxide is expressed by a general formula 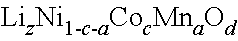
wherein, in the general formula, z, a, c, and d satisfy relations of 0.1≤z≤1.5, 0.5≤1−c−a≤1.0, 0≤c≤0.3, 0≤a≤0.3, and 1.5≤d≤2.1.
